(19) United States
(12) Patent Application Publication
(10) Pub. No.: US 2018/0030682 A1
(43) Pub. Date: Feb. 1, 2018

(54) A CONNECTION ADAPTER

(71) Applicant: Aydin Ozkan, Sincan, Ankara (TR)

(72) Inventor: Aydin Ozkan, Sincan, Ankara (TR)

(21) Appl. No.: 15/549,649

(22) PCT Filed: Jul. 29, 2015
(86) PCT No.: PCT/TR2015/000289

§ 371 Date: Aug. 8, 2017

(30) Foreign Application Priority Data
Feb. 10, 2015 (TR) 2015/01580
Jul. 7, 2015 (TR) 2015/08433

(51) Int. Cl. E02D 11/00; F16C 11/04

(52) U.S. Cl. CPC E02D 11/00; F16C 11/04; E02D 2600/20

(57) ABSTRACT

The present invention relates a connection adapter providing the connection of jaws (C) of every kind with vibro hammers (V) of every strength, which are used for driving and extracting of steel formed materials, profiles and steel pipes and further the connection adapter has at least one pressure member (4), which enables that the upper connection piece (2) and the lower connection piece (3) are interlocked by applying a force, if the interlocking of the upper connection piece (2) and the lower connection piece (3) is preferred.

### FIELD OF THE INVENTION

The present invention relates a connection adapter providing the connection of jaws of every kind with vibro hammers of every strength which are used for driving and extracting of steel formed materials, profiles and steel pipes.

### BACKGROUND OF THE INVENTION

Vibro hammers are mounted on parts such as steel formed pipes and profiles, and have wide application in driving and extracting these parts to and from the soil. Vibro hammers drive pipes or profiles to soil by means of their eccentric weights. In the cases, where a steel pipe should be driven into the soil, the pipe is brought in the upright position with respect to the ground plane and the vibro hammer is placed thereon, thereafter the steel pipe is pushed and thus driven into the soil by means of the force created through the vibration. There are jaws between the vibro hammer and the pipe. These jaws are attached to the material to be driven and causing, that the vibro hammer and the jaws act so, as they were one piece, whereby they act as a connection between the material and the vibro hammer. Each of the vibro hammers used nowadays has specific jaws. For a vibro hammer used currently, it is impossible to use a jaw of another vibro hammer. (Except the vibro hammers of equal strength).

The international patent application of the company DIESEKO with document number WO201301929 of the related art, relates to a vibro hammer having a jaw structure, which can move the parts in vertical and horizontal directions. In this patent application document, a hammer and driving method is explained. The vibration system with holder jaws has the capability to move between the horizontal and vertical axes.

The patent document no. EP0496167 of the company KENCHO KOBE, which is the state of art, a jaw structure is disclosed, which can be moved in horizontal and vertical axes by means of a remote control. By means of the said jaw structure is provided a freedom of movement while relocating the parts. In this patent, the jaw no. 16 is placed under the vibrator part. In the patent document, there is not any detailed information about the operation of the jaw.

### OBJECT OF THE INVENTION

The object of the invention is to provide a connection adapter, which can be easily connected to the jaws of vibro hammers of any kind.

Another object of the present invention is to realize a connection adapter, which can provide a connection between all sorts of jaws and all sorts of hammers.

### DETAILED DESCRIPTION OF THE INVENTION

A connection adapter developed to fulfill the objectives of the present invention is illustrated in the accompanying figures, in which;

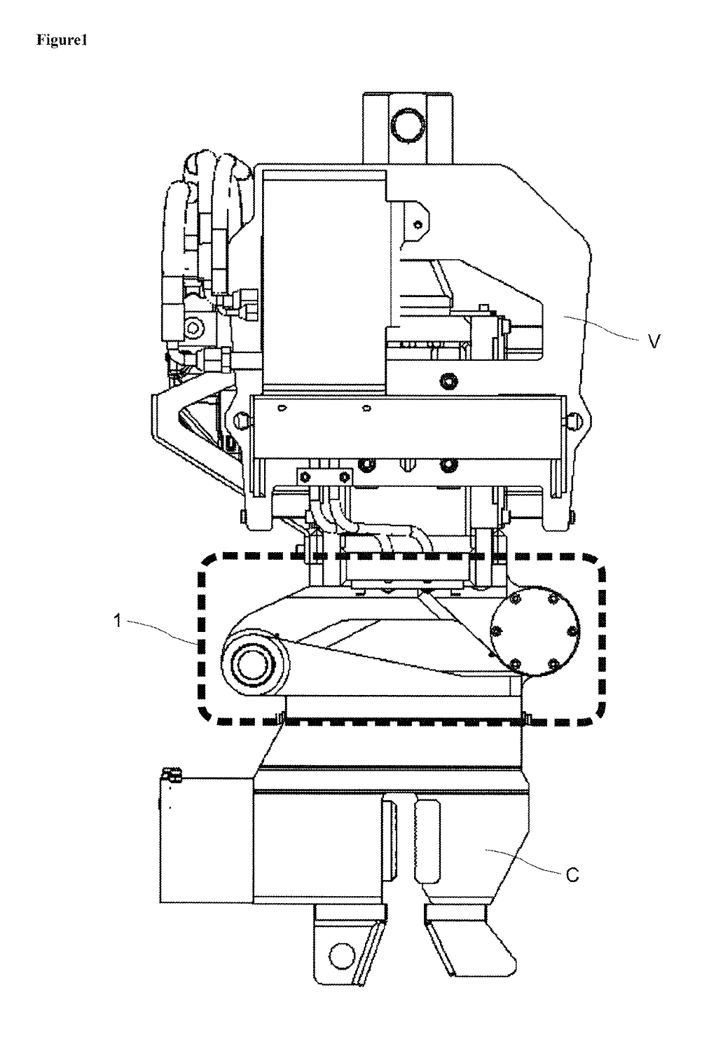

FIG. 1 is a side view of the connection adapter in locked position together with the jaw and vibro hammer.

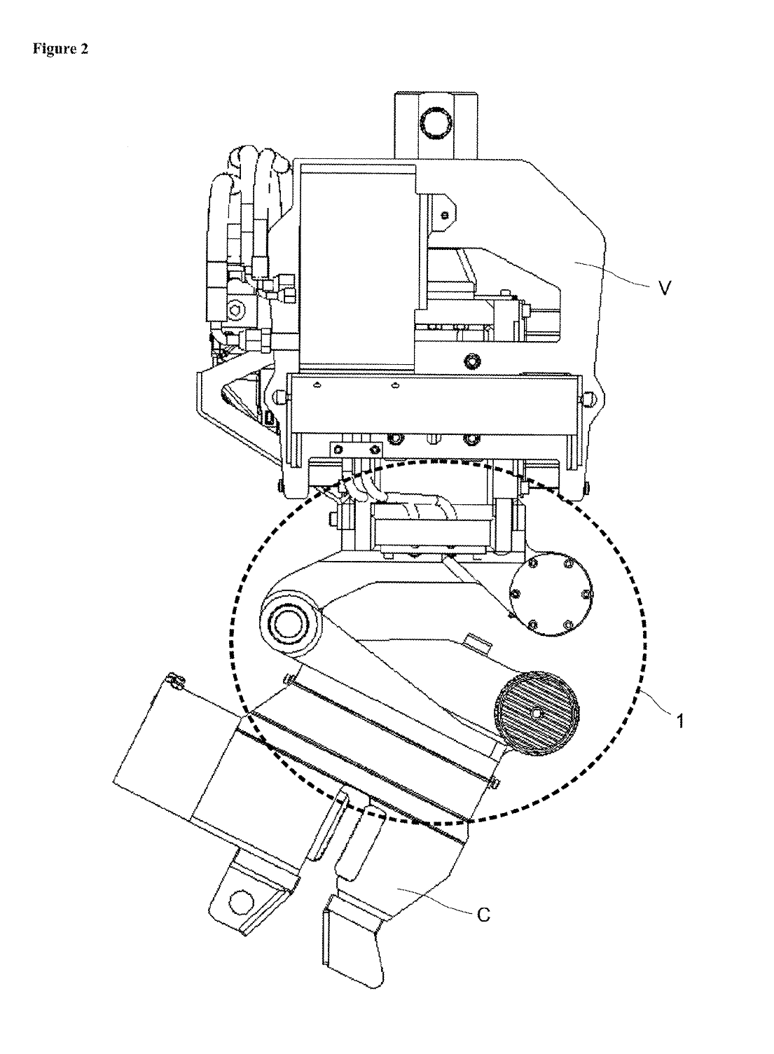

FIG. 2 is a side view of the connection adapter in free (angular moved) position together with the jaw and vibro hammer.

FIG. 3 is a perspective view of the connection adapter.

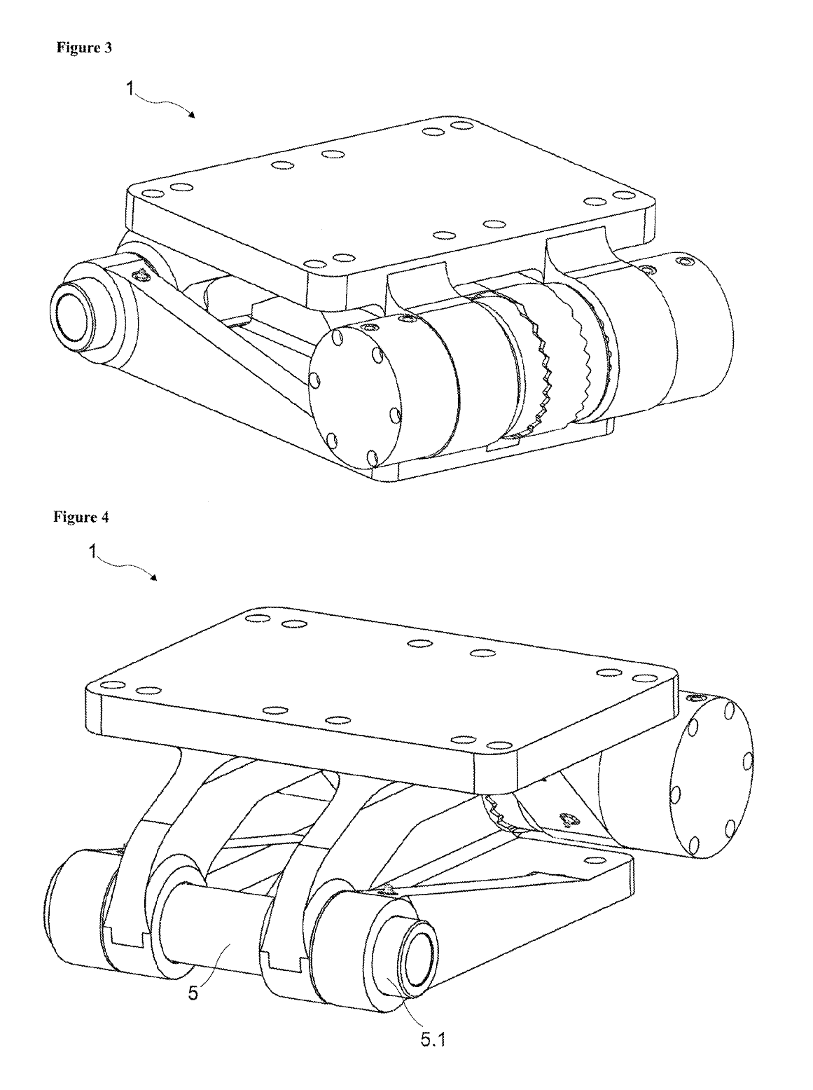

FIG. 4 is a perspective view of the connection adapter from a different viewpoint.

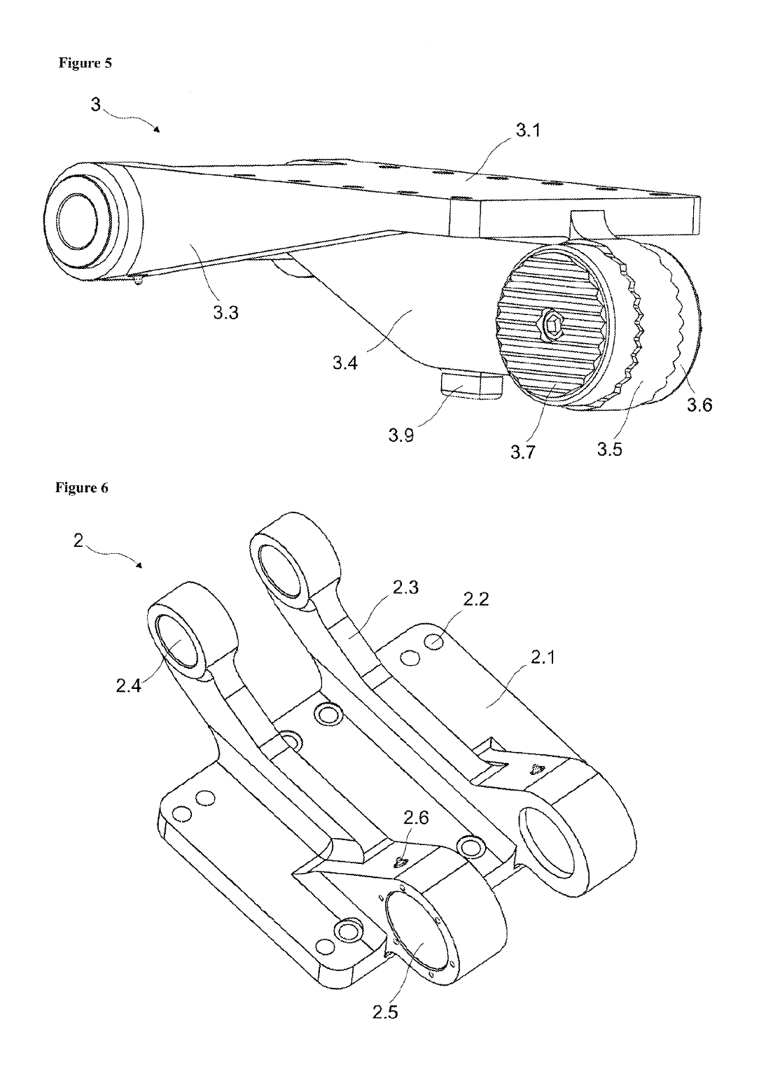

FIG. 5 is a perspective view of the lower connection piece.

FIG. 6 is a perspective view of the upper connection piece.

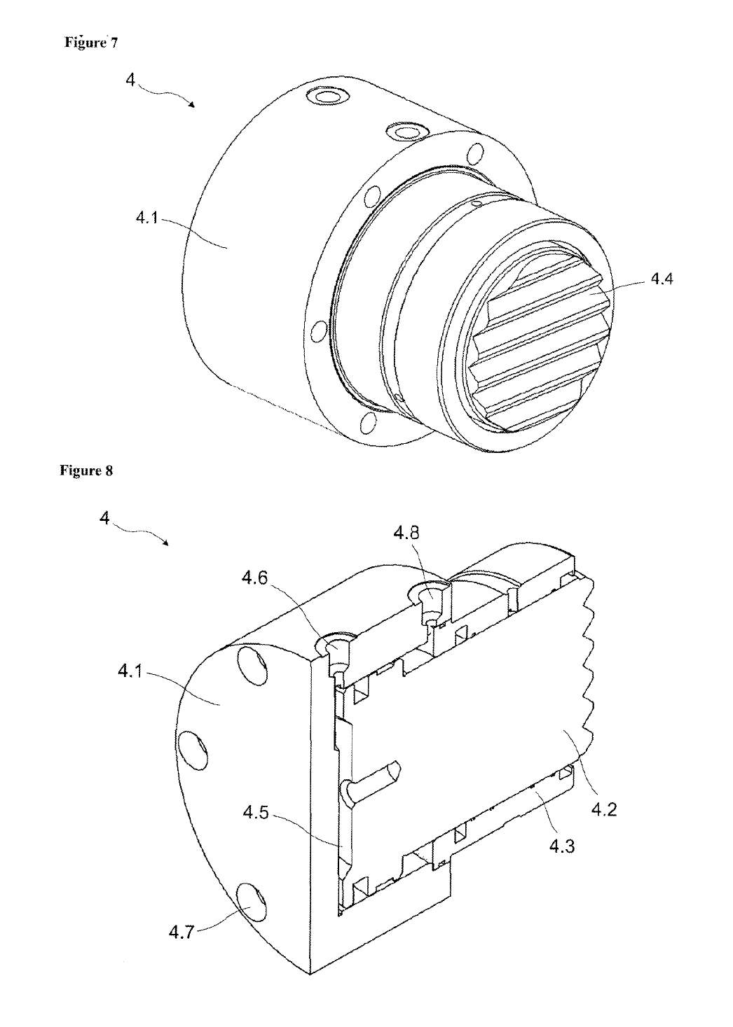

FIG. 7 is the perspective view of the pressure member.

FIG. 8 is a sectional view of the pressure member.

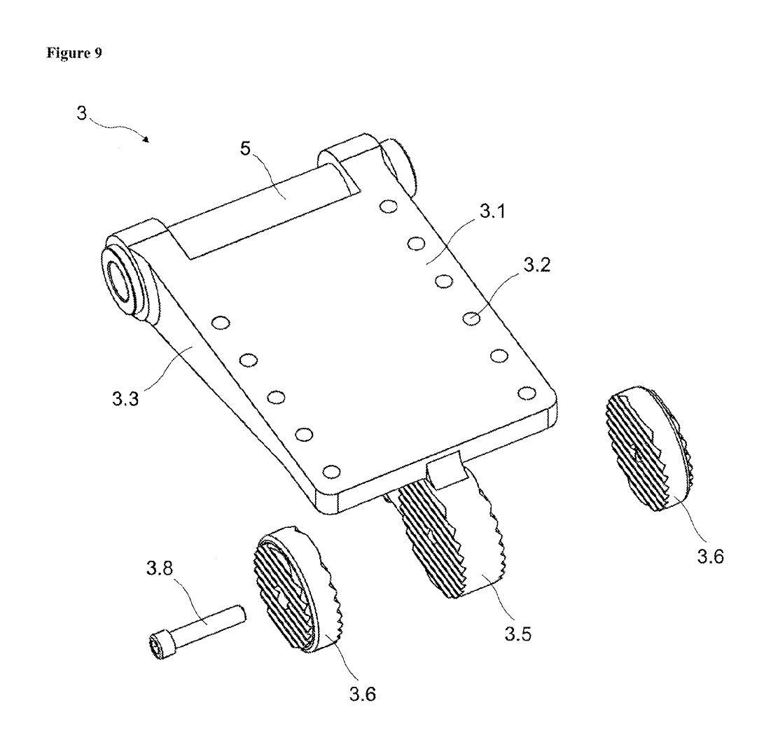

FIG. 9 is an exploded perspective view of the lower connection piece from a different viewpoint.

The components shown in the figures are each given reference numbers as follows:
1. Connection adapter
2. Upper connection piece
   2.1. Upper plate
   2.2. Upper connection hole
   2.3. Upper connection bracket
   2.4. Rotator element slot
   2.5. Fixing member slot
   2.6. Lubrication hole
3. Lower connection piece
   3.1. Lower plate
   3.2. Lower connection hole
   3.3. Lower connection bracket
   3.4. Fixing member bracket
   3.5. Connection apparatus
   3.6. Shoe
   3.7. Rib
   3.8. Connecting element
   3.9. Contact member
4. Pressure member
   4.1. Body
   4.2. Piston
   4.3. Retaining element
   4.4. Pressure rib
   4.5. Space
   4.6. Fluid hole
   4.7. Fixing holes
   4.8. Discharge opening
5. Spindle
   5.1. Spindle taper
C Jaw
V Vibro hammer

The connection adapter (1), which provides the connection of jaws (C) of every kind with vibro hammers (V) of every strength, which are used for driving and extracting of steel formed materials, profiles and steel pipes, comprising;
at least one upper connection piece (2) mounted to the jaw (C) or to the vibro hammer (V),
at least one lower connection piece (3) mounted to the vibro hammer (V) in the event that the upper connection piece (2) is connected to jaw (C) or mounted to jaw (C) in the event that the upper connection piece (2) is connected to the vibro hammer (V),
at least one upper plate (2.1), one face of which contacts to the jaw (C) or to the vibro hammer (V) and the other face of which faces the lower connection piece (3), having a certain wall thickness and upper connection holes (2.2) thereon for mounting of jaw (C) or vibro hammer (V),
at least one pressure member (4), which enables that the upper connection piece (2) and the lower connection piece (3) are interlocked by applying a force, if an interlock of the upper connection piece (2) and the lower connection piece (3) is preferred,
at least one lower plate (3.1), one face of which contacts the jaw (C) or the vibro hammer (V) and the other face of which faces the upper connection piece (2), having a certain wall thickness and lower connection holes (3.2) thereon for mounting of jaw (C) or vibro hammer (V),
at least one spindle (5), which is mounted so that the upper connection piece (2) and the lower connection piece (3) can move angularly to each other.

According to a connection adapter (1) in one embodiment of the invention, there is an upper connection piece (2). The upper connection piece (2) is mounted optionally to jaw (C) or to vibro hammer (V). There is provided an upper plate (2.1) on the upper connection piece (2). This upper plate (2.1) is preferably in a rectangular geometry and has a certain wall thickness. There are several upper connection holes (2.2) on the upper plate in order to mount the upper connection piece (2) to jaw (C) or to vibro hammer (V). The upper connection piece (2) is mounted to jaw (C) or to vibro hammer (V) by means of a connecting element, which is placed into these upper connection holes (2.2) and ensures that both of them act so as if they were one piece. There are several upper connection brackets (2.3) extending perpendicular to the upper plate (2.1) on the other face of the upper plate (2.1) which is not in contact with the jaw (C) or with the vibro hammer (V). The upper connection brackets (2.3) extend parallel to each other, whereas they are placed symmetrical to each other and equally to the centre of the upper plate (2.1). There are rotator element slots (2.4) drilled respectively on each one of the upper connection brackets (2.3) in order to dispose the spindle (5) thereto and the centerlines of which are congruent. The spindle (5) is disposed into these rotator element slots (2.4). The rotator element slots (2.4) are drilled wide enough so as the spindle (5) can act quite easily. Moreover, a fixing member slot (2.5) is drilled on the upper connection brackets (2.3). The centerlines of the fixing member slots (2.5) are also coincident, whereby the pressure member (4) is placed into these fixing member slots (2.5). A lubrication hole (2.6) is drilled close to the fixing member slots (2.5) in order to ensure that the pressure member (4) can move easily in these fixing member slots (2.5). The pressure member (4) can act easily in the fixing member slot (2.5) thanks to a lubricous movement facilitator, which is injected through the lubrication hole (2.6). Apart from the upper connection piece (2), there is also found a lower connection piece (3) on the connection adapter (1). The lower connection piece (3), if preferred, may be also mounted to the jaw (C) or to the vibro hammer (V) as in the case of the upper connection piece (2). There is also a lower plate (3.1) similarly to the upper plate (2.1) found on the lower connection piece (3), whereby several lower connection holes (3.2) are drilled into the lower plate (3.1) in order to ensure the mounting to the jaw (C) or to the vibro hammer (V). The lower plate (3.1) can also be fixed exactly to the jaw (C) or to the vibro hammer (V) by means of the connection elements passed through the lower connection holes (3.2). There is a lower connection bracket (3.3) of the lower plate (3.1), in which a hole is found, into which the spindle (5) can be placed, extending perpendicular to the lower plate (3.1) from the other face of the lower plate (3.1), which does not touch the jaw (C) or the vibro hammer (V). In addition to this, there is a fixing member bracket (3.4) on the lower plate (3.1) perpendicular to the lower plate, (3.1), found between the upper connection brackets (2.3) and extending parallel to the upper connection brackets (2.3), when the upper connection piece (2) and the lower connection piece (3) are combined. The lower connection bracket (3.3) and the fixing member bracket (3.4) are extending parallel to each other. There is a connection apparatus (3.5) at the one end of the fixing member bracket (3.4), which is formed so as to be concentric with the fixing member slot (2.5), when the connection apparatus (1) is closed. On each one of the both sides of this connection apparatus (3.5), there is a shoe (3.6). The shoe (3.6) mentioned here is preferably changeable, so as it can be replaced easily, when it should suffer a damage in any way. There are ribs (3.7) on the other side of the shoe (3.6), which does not face the connection apparatus (3.5). These ribs (3.7) are in contact with the pressure ribs (4.4) found on the pressure member (4) when a pressure is applied, and thus they increase the adherence considerably.

The interlocking of the shoes (3.6) existing on both sides of the connection apparatus (3.5) is performed by means of a connecting element (3.8). Thanks to fixing of the shoes (3.6) through the connecting element (3.8), these shoes (3.6) may be easily removed and replaced always when required. On that side of the fixing member bracket (3.4), which faces the upper plate (2.1), there is a contact member (3.9). When the upper plate (2.1) and the lower plate (3.1) are in parallel to each other, in other words when the upper connection piece (2) and the lower connection piece (3) are interlocked, a pressure is applied onto the lower plate (3.1) through the contact member (3.9) and thus provided, that the upper connection piece (2) and the lower connection piece (3) can act as a single piece. That the upper connection piece (2) and the lower connection piece (3) act as a single piece, it is also provided, when the pressure member (4) applies a pressure to the shoes (3.6). The here mentioned pressure member (4) is disposed into the fixing member slot (2.5) by means of the fixing members disposed into the fixing holes (4.7), whereby a body (4.1) is formed of a piston (4.2), which is able to move back and forth in the body (4.1) and of a retaining element (4.3), which acts as a guide for the piston (4.2) during its back and forth movement. At the end of the piston (4.2), there is a pressure rib (4.4), which is connected tightly with the rib (3.7), when pressure is applied. In cases where the pressure member (4) is active, the rib (3.7) and the pressure rib (4.4) are engaged one within the other and thus providing a full resistance to any potential shear force. Further, there is a space (4.5) between the body (4.1) and the piston (4.2). A pressure is created in the said space (4.5) by means of a fluid, which is directed through the fluid hole (4.6) and the piston (4.2) is moved by means of this pressure. In the case that the piston (4.2) would be released, the fluid were directed through the discharge opening (4.8) and the piston (4.2) would be moved in the reverse direction. The spindle (5) is passed to the rotator element slot (2.4) and further into a hole found in the lower connection bracket (3.3) and then fixed by means of a spindle taper (5.1) and its motion is limited in that location where it is placed. The use and working of the connection adapter (1) is performed as follows; The upper connection piece (2) found on the connection adapter (1) can be mounted, if preferred, to the jaw (C) or it can be mounted, if preferred, to the vibro hammer (V) by means of the connection elements disposed in the upper connection holes (2.2). In addition to this, the lower connection piece (3) is mounted to the other component, namely to the jaw (C) or to the vibro hammer (V), where the upper connection piece (2) is not mounted. The lower connection piece (3) is fixed like the upper connection piece (2) was fixed. The connection of the upper connection piece (2) and the lower connection piece (3) to each other is performed solely by means of the spindle (5) while the connection adapter (1) is in the released position. The rotating point of the angular motion of the upper connection piece (2) and the lower connection piece (3) relative to each other is likewise that point, where the spindle (5) is found. When the connection adapter (1) is released, in other words in cases where the pressure member (4) does not apply pressure to the rib (3.7), the upper connection piece (2) and the lower connection piece (3) are released and they can move around that point freely, where the spindle (5) is found. In this position there is a certain angle between the upper plate (2.1) and the lower plate (3.1). Afterwards, in this position, when any component (steel formed materials, profiles and steel pipes) is placed to the jaw (C) and when this component is brought in a position perpendicular to the ground plane and made ready to be driven, then the upper plate (2.1) and the lower plate (3.1) are brought in a parallel position to each other. In the case that the upper plate (2.1) and the lower plate (3.1) are brought to a parallel position to each other, the centerline of pressure member (4) and the centerline of the rib (3.7) are getting the same line and the piston (4.2) is progressed in direction of the rib (3.7) thanks to directing the fluid through the fluid hole (4.6) into the space (4.5). As a result of the progressing, the pressure rib (4.4) and the rib (3.7) are interlocked fully and are positioned so as they are able to put up a resistance against potential forces of any kind. At this stage the upper connection piece (2) and the lower connection piece (3) behave like a single piece and act as a single part against the high frequency vibrations created by the vibro hammer (V). If the connection adapter (1) is preferably released, the pressure force created at the pressure member (4) is removed and as the connection between the upper connection piece (2) and the lower connection piece (3) is reduced to just a point, the angular free motion can be restored.

1. A connection adapter (1), which provides the connection of jaws (C) of every kind with vibro hammers (V) of every strength, which are used for driving and extracting of steel formed materials, profiles and steel pipes, characterized by
at least one upper connection piece (2) mounted to the jaw (C) or to the vibro hammer (V),
at least one lower connection piece (3) mounted to the vibro hammer (V) in the event that the upper connection piece (2) is connected to the jaw (C) or mounted to the jaw (C) in the event that the upper connection piece (2) is connected to the vibro hammer (V),
at least one upper plate (2.1), one face of which contacts to the jaw (C) or to the vibro hammer (V) and the other face of which faces the lower connection piece (3), having a certain wall thickness and upper connection holes (2.2) thereon for mounting of jaw (C) or vibro hammer,
at least one pressure member (4), which ensures that the upper connection piece (2) and the lower connection piece (3) are interlocked by applying a force, if an interlock of the upper connection piece (2) and the lower connection piece (3) is preferred,
at least one lower plate (3.1), one face of which contacts the jaw (C) or the vibro hammer (V) and the other face of which faces the upper connection piece (2), having a certain wall thickness and lower connection holes (3.2) thereon for mounting of jaw (C) or vibro hammer (V),
at least one spindle (5), which is mounted so that the upper connection piece (2) and the lower connection piece (3) can move angularly to each other.

2. Connection adapter (1) according to claim (1), characterized by an upper plate (2.1) which is preferably in a rectangular geometry and with a certain wall thickness and further comprising several upper connection holes (2.2) thereon in order to mount the upper connection piece (2) to jaw (C) or to vibro hammer.

3. Connection adapter (1) according to claim 1, characterized by several upper connection brackets (2.3) extending perpendicular to the upper plate (2.1) on the other face of the upper plate (2.1) which is not in contact with the jaw (C) or with the vibro hammer (V) and which extend parallel to each other, whereas they are placed symmetrical to each other and equally to the centre of the upper plate (2.1).

4. Connection adapter (1) according to claim 1, characterized by the rotator element slot (2.4) drilled respectively on each one of the upper connection brackets (2.3) in order to dispose the spindle (5) thereto and the centerlines of which are congruent and further which are drilled wide enough, so that the spindle (5) can act easily.

5. Connection adapter (1) according to claim 1, characterized by fixing member slots (2.5) drilled at the upper connection brackets (2.3), centerlines of which are coincident and whereby the pressure member (4) is placed hereinto.

6. Connection adapter (1) according to claim 1, characterized by a lubrication hole (2.6) drilled close to the fixing member slots (2.5) in order to ensure that the pressure member (4) can move easily in the fixing member slots (2.5).

7. Connection adapter (1) according to claim 1, characterized by the lubrication hole (2.6), which enables that the pressure member (4) can act easily in the fixing member slot (2.5) thanks to a lubricous movement facilitator, which is injected through the lubrication hole.

8. Connection adapter (1) according to claim 1, characterized by the lower connection piece (3), which can be mounted, depending on preferences, to jaw (C) or to vibro hammer (V).

9. Connection adapter (1) according to claim 1, characterized by several lower connection holes (3.2) found in the lower plate (3.1) in order to enable the mounting to jaw (C) or to vibro hammer (V).

10. Connection adapter (1) according to claim 1, characterized by the lower connection bracket (3.3) of the lower plate (3.1), in which a hole is found, into which the spindle (5) can be placed, extending perpendicular to the lower plate (3.1) from the other face of the lower plate (3.1), which does not touch the jaw (C) or the vibro hammer (V).

11. Connection adapter (1) according to claim 1, characterized by the fixing member bracket (3.4) rising perpendicular to the lower plate, (3.1), found between the upper connection brackets (2.3) and extending parallel to the upper connection brackets (2.3), when the upper connection piece (2) and the lower connection piece (3) are combined.

12. Connection adapter (1) according to claim 1, characterized by the fixing member bracket (3.4), which extends parallel to lower connection bracket (3.3).

13. Connection adapter (1) according to claim 1, characterized by the connection apparatus (3.5) at the one end of the fixing member bracket (3.4), which is formed so as to be concentric with the fixing member slot (2.5), when the connection apparatus (1) is closed.

14. Connection adapter (1) according to claim 1, characterized by the shoe (3.6) on each one of the both sides of the connection apparatus (3.5) preferably changeable, so as it can be replaced easily, when it should suffer a damage in any way.

15. Connection adapter (1) according to claim 1, characterized by the rib (3.7) found on the other side of shoe (3.6), which does not face the connection apparatus (3.5), whereby the rib is continuously in contact with the pressure rib (4.4) found on the pressure member (4) when a pressure is applied.

16. Connection adapter (1) according to claim 1, characterized by the connecting element (3.8), which provides the interlocking of shoes (3.6) existing on both sides of the connection apparatus (3.5).

17. Connection adapter (1) according to claim 1, characterized by the contact member (3.9) found on the that side of the fixing member (3.4), which faces the upper plate (2.1) and applying pressure onto the lower plate (3.1), when the upper plate (2.1) and the lower plate (3.1) are parallel to each other, in other words when the upper connection piece (2) and the lower connection piece (3) are interlocked.

18. Connection adapter (1) according to claim 1, characterized by pressure member (4) having a body (4.1) which is disposed into the fixing member slot (2.5) by means of fixing members placed into the fixing holes (4.7).

19. Connection adapter (1) according to claim 1, characterized by pressure member (4) having a body (4.1) formed of a piston (4.2), which is able to move back and forth in the body (4.1) and of a retaining element (4.3), which acts as a guide for the piston (4.2) during its back and forth movement.

20. Connection adapter (1) according to claim 1, characterized by the pressure rib (4.4) found at the end of the piston (4.2) and engaging with the rib (3.7) very tightly, if a pressure is applied.

21. Connection adapter (1) according to claim 1, characterized by the pressure member (4), which enables, if it is active, that the rib (3.7) and the pressure rib (4.4) are engaged one within the other and thus providing a full resistance to any potential shear force.

22. Connection adapter (1) according to claim 1, characterized by a space (4.5) between the body (4.1) and the piston (4.2) and to which a pressure is applied by means of a fluid directed from inside of the fluid hole (4.6).

23. Connection adapter (1) according to claim 1, characterized by the discharge opening (4.8) through which the fluid were directed and the piston (4.2) would be moved in the reverse direction if the piston (4.2) would be released.

24. Connection adapter (1) according to claim 1, characterized by the spindle (5) which is passed to the rotator element slot (2.4) and further into a hole found in the lower connection bracket (3.3) and then fixed by means of a spindle taper (5.1).
